(19) United States
(12) Patent Application Publication
(10) Pub. No.: US 2017/0308546 A1
(43) Pub. Date: Oct. 26, 2017

(54) FILE STORAGE METHOD AND ELECTRONIC DEVICE

(71) Applicants: Le Holdings (Beijing) Co., Ltd., Beijing (CN); Le Cloud Computing Co., Ltd., Beijing (CN)

(72) Inventor: Yangang XIA, Beijing (CN)

(21) Appl. No.: 15/352,105

(22) Filed: Nov. 15, 2016

Related U.S. Application Data
(63) Continuation of application No. PCT/CN2016/100061, filed on Sep. 26, 2016.

(30) Foreign Application Priority Data
Apr. 25, 2016 (CN) 201610262860.1

(51) Int. Cl. G06F 17/30; G06F 3/06

(52) U.S. Cl. CPC G06F 17/30138; G06F 17/30117; G06F 17/30085; G06F 3/0608; G06F 3/0653; G06F 3/0652; G06F 3/0674

(57) ABSTRACT

The embodiments of the present application provide a file storage method and an electronic device. The file storage method includes: receiving a file to be stored; determining a currently stored folder with a lowest storage priority after the storage space of a disk exceeds a preset threshold; and selecting and deleting a file from the determined folder, and storing the file to be stored in the disk. The embodiments of the present application can improve the utilization value of the storage space of the disk and further improve the performances of the video server; since the files with higher priority are retained, when called, these files do not need to be regenerated or obtained from other servers, thereby improving the utilization rate of system resources and also enhancing the experience of a video requested by the user.

### CROSS-REFERENCE TO RELATED APPLICATIONS

This application is a continuation of International Application No. PCT/CN2016/100061, filed on Sep. 26, 2016, which is based upon and claims priority to Chinese Patent Application No. 201610262860.1, filed on Apr. 25, 2016, the entire contents of which are incorporated herein by reference.

### TECHNICAL FIELD

The present application relates to the field of file storage, and particularly to a file storage method and electronic device.

### BACKGROUND

A video server is a special device which performs coding processing on audio and video data and transmits them over network, and usually integrates processing, concluding, editing, storing and collecting of audio and video data.

Since the video server is in charge of providing massive video files, the storage performance for the video files becomes an important aspect on the performances of the video server. In a case that the storage space of a disk of the server is fixed, how to improve the utilization value of the storage space of the disk is a key to improve the performances of the video server.

At present, after the storage space of the disk is full, the files with the longest storage time may be deleted, this manner leads to a problem that some valuable files with higher accessing frequency are deleted, but some files having a shorter storage time but lower accessing frequency are retained. For example, if the files with higher accessing frequency are deleted, when required to be called later, these files have to be regenerated or obtained, which wastes system resources and reduces the performances of the video server.

Obviously, in the prior art, a utilization value of the storage space of the disk is low, which becomes a bottleneck of influencing the performances of the video server.

### SUMMARY

The embodiments of the present application present application provide a file storage method and an electronic device, aiming to solve the problem in the prior art that a utilization value of the storage space of the disk is low, which becomes a bottleneck of influencing the performances of the video server.

In a first aspect, the embodiment of the present application provides a file storage method, including:

receiving a file to be stored;

determining a currently stored folder with a lowest storage priority after the storage space of a disk exceeds a preset threshold; and

selecting and deleting a file from the determined folder, and storing the file to be stored in the disk.

In a second aspect, the embodiment of the present application further provides a non-transitory computer storage medium storing a computer executable instruction, where the computer executable instruction is set for:

receiving a file to be stored;

determining a currently stored folder with a lowest storage priority after the storage space of a disk exceeds a preset threshold; and

selecting and deleting a file from the determined folder, and storing the file to be stored in the disk.

In a third aspect, the embodiment of the present application further provides an electronic device, including: at least one processor and a memory, where the memory stores a program executable by the at least one processor, and execution of the instructions by the at least one processor causes the at least one processor to:

receive a file to be stored;

determine a currently stored folder with a lowest storage priority after the storage space of a disk exceeds a preset threshold; and

select and delete a file from the determined folder, and store the file to be stored in the disk.

In the solution provided by the embodiments of the present application, when receiving the file to be stored, the server determines a deleting order of all files stored in different folders according to the storage priority corresponding to each folder, when the storage space of the disk exceeds a preset threshold, the file in the folder with the lowest storage priority is deleted every time, the file in the folder with higher priority is retained, then the above file to be stored is stored in the disk, thereby improving the utilization value of the storage space of the disk, and further improving the performances of the video server; since the files with higher priority are retained, when called, these files do not need to be regenerated or obtained from other servers, thereby improving the utilization rate of system resources and also enhancing the experience of a video requested by the user.

Other features and advantages of the present application will be explained in the subsequent description, and partially become obvious from the description, or are known by implementing the present application. The objective and other advantages of the present application can be realized and obtained by specifically indicated structures in the description, claims and accompanying drawings.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flow diagram of a file storage method in accordance with some embodiments;

FIG. 2 is a schematic flow diagram of a file storage method in accordance with some embodiments;

FIG. 3 is a flow schematic diagram of a file storage method in accordance with some embodiments;

FIG. 4 is a detailed schematic flow diagram of a file storage method in accordance with some embodiments;

FIG. 5 is a structural schematic diagram of a file storage apparatus in accordance with some embodiments; and

FIG. 6 is a hardware structural schematic diagram of an electronic device executing file storage in accordance with some embodiments;

FIG. 7 is a schematic diagram of an electronic device executing file storage in accordance with some embodiments.

### DETAILED DESCRIPTION

In order to make the objective, technical solution and advantages of the embodiments of the present application more apparent, the technical solution in the embodiments of the present application will be clearly and completely described below with reference to the drawings in the embodiments of the present application. Obviously, the embodiments to be described are just partial embodiments of the present application instead of all embodiments. Based upon the embodiments here of the application, all of other embodiments derived by those ordinarily skilled in the art without any inventive effort shall come into the scope of the application.

### First Embodiment

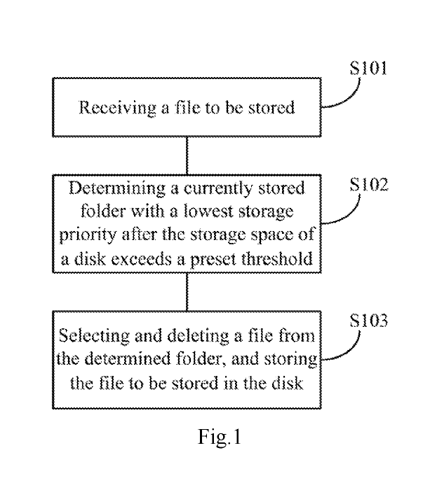

FIG. 1 shows a schematic flow diagram of a file storage method according to a first embodiment of the present application, which includes the following steps:

S101: receiving a file to be stored;

S102: determining a currently stored folder with a lowest storage priority after the storage space of a disk exceeds a preset threshold; and

S103: selecting and deleting a file from the determined folder, and storing the file to be stored in the disk.

In a specific implementation, when receiving a new file and needs to store the file, a server can prejudge the storage space of the disk to timely delete historical files and reserve the storage space for the file to be stored. If the server directly stores the file to be stored into the disk, and deletes the historical files after judging that the storage space of the disk is insufficient while the file is being stored, the storage of the file to be stored may be interfered, leading to a damage to the file or even having an influence on the normal operation of the disk in a severe case.

Specifically, the deleting order of the files stored in different folders is determined according to the storage priority corresponding to each folder, such that the files in the folder with the lowest storage priority are deleted every time, and the file with higher importance or frequently used by the user can be prevented from being deleted.

Further, the preset threshold in the step 102 can be a constant preset value to reserve a sufficient storage space for a temporary file possibly generated during operation of the disk and the file to be stored; the above preset threshold can alternatively be determined according to the size of the file to be stored using a preset algorithm after the server receives the file to be stored; in addition, the storage space of the disk can generally be determined to exceed the preset threshold when the storage space of the disk is full.

Preferably, the step 102 specifically includes: determining a currently stored folder with a lowest storage priority after the storage space of the disk is full.

Specifically, when the storage space of the disk is full, the storage space of the disk is determined to exceed the preset threshold. With such a simple and easy method, the storage space of the disk can be fully used, and an unnecessary operation burden to the server can be avoided.

As can be seen, in the embodiment of the present application, when receiving the file to be stored, the server determines a deleting order of all storage files in different folders according to the storage priority corresponding to each folder, when the storage space of the disk exceeds a preset threshold, the file in the folder with the lowest storage priority is deleted every time, the file in the folder with higher priority is retained, then the above file to be stored is stored in the disk, thereby improving the utilization value of the storage space of the disk, and further improving the performances of the video server. In addition, since the files with higher priority are retained, when called later, these files do not need to be regenerated or obtained from other servers, thereby improving the utilization rate of system resources and also enhancing the experience of a video requested by the user.

### Second Embodiment

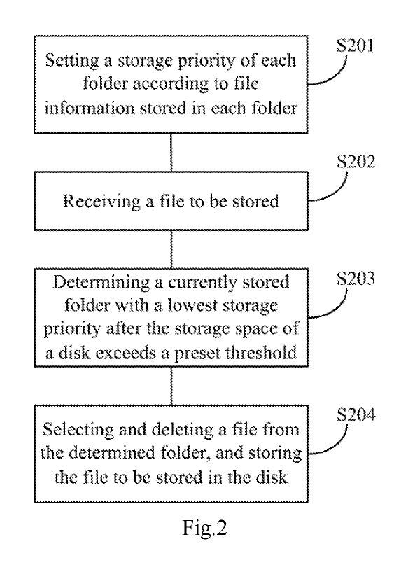

FIG. 2 shows a schematic flow diagram of a file storage method according to a second embodiment of the present application, which includes the following steps:

S201: setting a storage priority of each folder according to file information stored in each folder;

S202: receiving a file to be stored;

S203: determining a currently stored folder with a lowest storage priority after the storage space of a disk exceeds a preset threshold; and

S204: selecting and deleting a file from the determined folder, and storing the file to be stored in the disk.

Specifically, the storage priority of each folder can be preset when the server initially operates, and can also be set according to different preset rules in an operation process of the server.

Preferably, in the step S201, in the operation process of the server, the storage priority of each folder is set according to the file information stored in each folder. Since the file information stored in the folder usually can comprehensively and directly reflect the importance of the file stored in the folder to the server or the user, the storage priority of the folder is set according to the file information, where a higher storage priority is set for the folder with higher importance, and a lower storage priority is set for the folder with lower importance, to thereby determine a deleting order of the files stored in different folders, and reduce the probability of mistaken deletion.

The above file information can include file content and/or file attribute information, that is, the step S201 can specifically include: setting a storage priority of each folder according to file content and/or file attribute information of each of all files stored in each folder.

Specifically, the above file content can be determined according to information such as file name, keyword, etc., the above file attribute information can include information such as file type, file size, creator, creating time, etc. The above file content and file attribute information can more comprehensively reflect the storage state of the file in the disk, thereby embodying the importance of the above file to the server or user. Therefore, the storage priority of each folder can be set according to the file content and file attribute information of the file separately or simultaneously.

Further, the step 201 specifically includes: setting a storage priority of each folder according to an accessing frequency of each of all files stored in each folder in a latest preset time period.

Generally speaking, the above accessing frequency can directly reflect the demands of the user on the file, and the method of setting the storage priority of each folder according to the accessing frequency is simple, easy and efficient. In addition, since the overall accessing frequency of the file with shorter storage time must be smaller than that of the file with longer storage time, in order to prevent the file from being deleted mistakenly and to avoid a burden to the operation and storage of the server, only the accessing frequency of the file in the latest preset time period is counted, and the preset time period is determined according to factors such as the processing capacity of the server, the overall accessing frequency of the user to the server, etc.

Specifically, the setting a storage priority of each folder according to an accessing frequency of each of all files stored in each folder in a latest preset time period can be performed by counting a sum of the access frequency of each of all files stored in each folder in the latest preset time period, where the larger the sum of the accessing frequency is, the higher the storage priority is set for the folder; or by counting a sum of the number of files, of which the accessing frequency exceeds a preset accessing frequency, stored in each folder in the latest preset time period, where the larger the number of the files is, the higher the storage priority is set for the folder, etc.

As can be seen, with the file storage method according to the second embodiment of the present application, the storage priority of the folder can be set according to the importance of the file stored in the folder to the server or user, the file in the folder with higher storage priority is retained as much as possible, thereby improving the utilization value of the storage space of the disk and improving the performances of the video server. In addition, since the files with higher priority are retained, when called later, these files do not need to be regenerated or obtained from other servers, thereby improving the utilization rate of system resources and also enhancing the experience of a video requested by the user.

### Third Embodiment

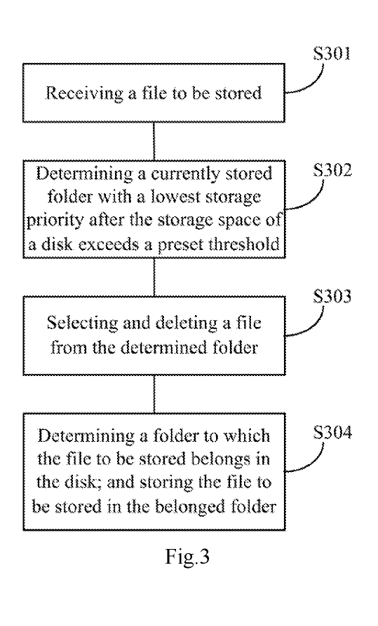

FIG. 3 shows a schematic flow diagram of a file storage method according to a third embodiment of the present application, which includes the following steps:

S301: receiving a file to be stored;

S302: determining a currently stored folder with a lowest storage priority after the storage space of a disk exceeds a preset threshold;

S303: selecting and deleting a file from the determined folder; and

S304: determining a folder to which the file to be stored belongs in the disk, and storing the file to be stored in the belonged folder.

In a specific implementation, after a file is deleted and enough storage space of the disk is reserved, then the file to be stored is stored. Since different storage priorities are respectively determined for folders for storing files in the disk, preferably, when storing the file to be stored, the folder to which the file to be stored belongs can be determined previously.

Specifically, the folder to which the file to be stored belongs can be determined according to the method of setting the storage priority of each folder. For example, when the storage priority of each folder is set according to the file content and/or file attribute information of each of all files stored in each folder, the folder to which the file to be stored belongs can be determined according to the file content and/or file attribute information of the file to be stored, and the file to be stored is stored in the belonged folder; when the storage priority of each folder is set according to the accessing frequency of each of all files stored in each folder in the latest preset time period, the folder with higher accessing frequency can be determined as the folder to which the file to be stored belongs, to thereby avoid the file from being deleted mistakenly in the subsequent operation of the server due to the influence on a comprehensive accessing frequency of the whole folder since the storage time of the file to be stored is shorter and its accessing frequency is lower than that of the file with longer storage time. Obviously, the folder to which the file to be stored belongs can also be determined by adopting different methods according to other methods setting the storage priority of each folder, or the file to be stored can be randomly stored in certain one folder, and all of these methods have higher feasibility. The above embodiments are examples and do not limit the solution provided by the present application.

As can be seen, with file storage method according to the third embodiment of the present application, the file to be stored can be stored in the belonged folder, and the file in the folder with higher storage priority is retained, thereby improving the utilization value of the storage space of the disk, and further improving the performances of the video server. In addition, since the files with higher priority are retained, when called later, these files do not need to be regenerated or obtained from other servers, thereby improving the utilization rate of system resources and also enhancing the experience of a video requested by the user.

### Fourth Embodiment

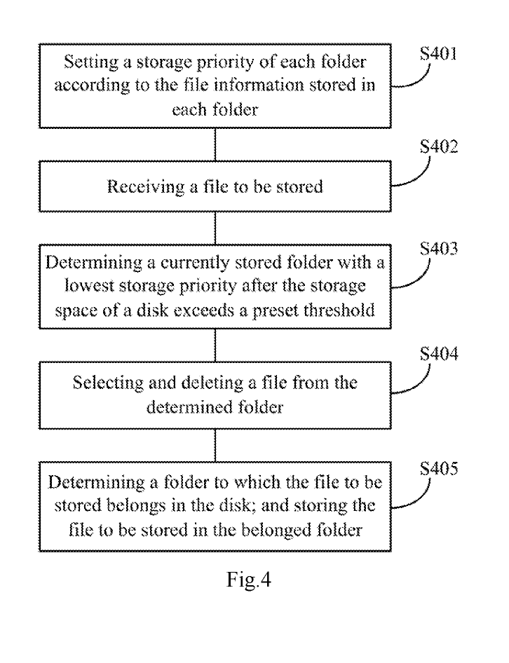

FIG. 4 shows a detailed schematic flow diagram of a file storage method according to a fourth embodiment of the present application, which includes the following steps:

S401: setting a storage priority of each folder according to the file information stored in each folder;

S402: receiving a file to be stored;

S403: determining a currently stored folder with a lowest storage priority after the storage space of a disk exceeds a preset threshold;

S404: selecting and deleting a file from the determined folder; and

S405: determining a folder to which the file to be stored belongs in the disk, and storing the file to be stored in the belonged folder.

As can be seen, with file storage method according to the fourth embodiment of the present application, the file to be stored can be stored in the belonged folder, and the storage priority of the folder can be set according to the importance of the file stored in the folder to the server or user, thereby retaining the file in the folder with higher priority, improving the utilization value of the storage space of the disk and improving the performances of the video server. In addition, since the files with higher priority are retained, when called later, these files do not need to be regenerated or obtained from other servers, thereby improving the utilization rate of system resources and also enhancing the experience of a video requested by the user.

### Fifth Embodiment

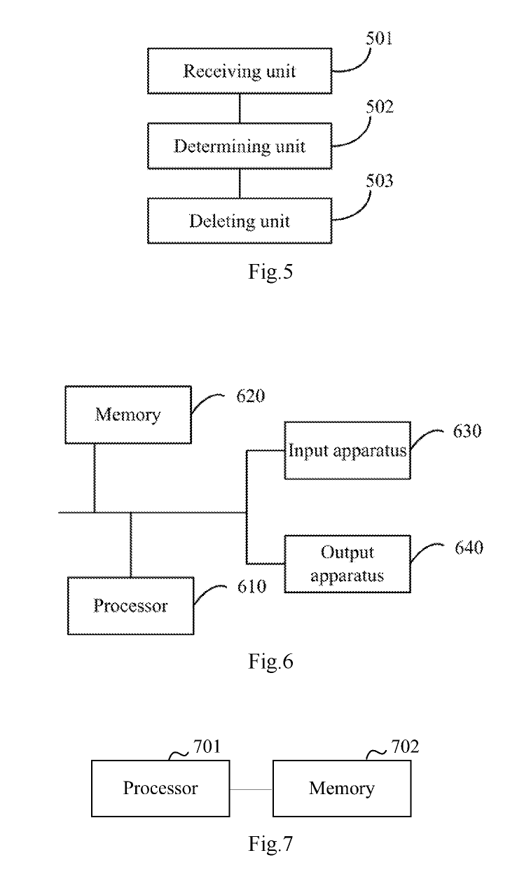

FIG. 5 is a structural schematic diagram of a file storage apparatus according to a fifth embodiment of the present application, which includes the following units:

A receiving unit 501, configured to receive a file to be stored;

A determining unit 502, configured to determine a currently stored folder with a lowest storage priority after the storage space of a disk exceeds a preset threshold; and

A deleting unit 503, configured to select and delete a file from the determined folder, and store the file to be stored in the disk.

Further, the apparatus also includes a setting unit, configured to set a storage priority of each folder according to file information stored in each folder.

Further, the setting unit is specifically configured to set a storage priority of each folder according to file content and/or file attribute information of each of all files stored in each folder.

Further, the setting unit is specifically configured to set a storage priority of each folder according to an accessing frequency of each of all files stored in each folder in a latest preset time period.

Further, the deleting unit 503 is specifically configured to determine a folder to which the file to be stored belongs in the disk; and store the file to be stored in the belonged folder.

Further, the determining unit 502 is specifically configured to determine the currently stored folder with the lowest storage priority after the storage space of the disk is full.

In conclusion, in the solution provided by the embodiment of the present application, when the server receives the file to be stored, the deleting order of the files stored in different folders is determined according to the storage priority corresponding to each folder, the file in the folder with the lower storage priority is deleted every time after the storage space of the disk exceeds a preset threshold, the file in the folder with the higher storage priority is retained, then the file to be stored is stored in the disk, thereby improving the utilization value of the storage space of the disk, and further improving the performances of the video server. In addition, since the files with higher priority are retained, when called later, these files do not need to be regenerated or obtained from other servers, thereby improving the utilization rate of system resources and also enhancing the experience of a video requested by the user.

### Sixth Embodiment

A sixth embodiment of the present application provides a non-transitory computer storage medium storing a computer executable instruction, and the computer executable instruction can execute the file storage method in any method embodiment above.

### Seventh Embodiment

FIG. 6 is a hardware structural schematic diagram of an electronic device executing file storage according to a seventh embodiment of the present application, as shown in FIG. 6, the electronic device includes:

One or more processors 601 and a memory 602, and FIG. 6 takes one processor 610 as an example.

The electronic device executing the file storage also includes: an input apparatus 630 and an output apparatus 640.

The processor 610, the memory 620, the input apparatus 630 and the output apparatus 640 can be connected via a bus or other manners, and FIG. 6 takes the bus connection as an example.

The memory 620 as a non-transitory computer storage medium can be configured to store non-transitory software programs, and non-transitory computer executable programs and modules, for example, the program instructions/modules/units corresponding to the file storage method in the embodiment of the present application (for example, the receiving unit 501, the determining unit 502 and the deleting unit 503 as shown in FIG. 5). The processor 610 performs various function applications and data processing of the server by executing the non-transitory software programs, instructions and modules stored in the memory 620, that is, the file storage method in the above method embodiment is realized.

The memory 620 can include a program storing region and a data storing region, wherein the program storing region can store an operation system and the application program required by at least one function; the data storing region can store data created according to the use of the electronic device for file storage, etc. In addition, the memory 620 can include a high speed random access memory, and can also include a non-transitory memory, for example at least one disk memory device, a flash device or other non-transitory solid memory devices. In some embodiments, the memory 620 can include memories remotely disposed relative to the processor 610, and these remote memories can be connected to the electronic device for file storage via a network. The instances of the network include but not limited to internet, enterprise intranet, local area network, mobile communication network and combinations thereof.

The input apparatus 630 can receive input numbers or character information, and generate a key signal input related to user setting and functional control of the electronic device for file storage. The output apparatus 640 can include a display device such as a display screen.

The one or more modules are stored in the memory 620, and execute the file storage method in any above method embodiment when executed by one or more processors 610.

The above product can execute the method provided by the embodiment of the present application, and has corresponding function modules for executing the method and advantageous effects. The technical details not described in detail in the present embodiment can refer to the method provided by the embodiments of the present application.

Based upon the same inventive idea, an embodiment of the disclosure further provides an electronic device executing file storage, as illustrated in FIG. 7, which includes:

At least one processor 701 and a memory 702, where there is one processor as an example in FIG. 7.

The memory 702 is communicably connected with the at least one processor 701 for storing instructions executable by the at least one processor, wherein execution of the instructions by the at least one processor causes the at least one processor to:

Receive a file to be stored;

Determine a currently stored folder with a lowest storage priority after the storage space of a disk exceeds a preset threshold; and

Select and delete a file from the determined folder, and store the file to be stored in the disk.

In one embodiment, the execution of the instructions by the at least one processor further causes the at least one processor to:

Set a storage priority of each folder according to file information stored in each folder.

In one embodiment, the execution of the instructions by the at least one processor further causes the at least one processor to:

Set a storage priority of each folder according to file content and/or file attribute information of each of all files stored in each folder.

In one embodiment, the execution of the instructions by the at least one processor further causes the at least one processor to:

Set a storage priority of each folder according to an accessing frequency of each of all files stored in each folder in a latest preset time period.

In one embodiment, the execution of the instructions by the at least one processor further causes the at least one processor to:

Determine a folder to which the file to be stored belongs in the disk; and

Store the file to be stored in the determined folder.

The electronic device of the embodiment of the present application exists in multiple forms, including but not limited to:

(1) Mobile communication devices: such type of devices has the characteristic of a mobile communication function, and takes providing of voice and data communication as a primary target. Such type of terminals includes a smart phone (for example, iPhone), a multimedia phone, a functional phone and a low class phone, etc.;

(2) Ultra mobile personal computer devices: such type of devices belongs to the domain of personal computers, has operation and processing functions and generally has a mobile networking property. Such type of terminals includes: PDA, MID, and UMPC devices, for example iPad;

(3) Portable entertainment devices: such type of devices can display and play a multimedia content. Such type of devices includes: an audio and video player (for example, iPod), a handheld game player, e-books, smart toys and portable vehicle-mounted navigation devices;

(4) Servers: a device providing computing services, the server consists of a processor, a hard disk, a memory, a system bus, etc. The server has an architecture similar to a universal computer, but has higher demands on processing capacity, stability, reliability, safety, expandability, manageability, etc., due to the need of providing high reliability services;

(5) Other electronic devices with a data interaction function.

The embodiments of the apparatus described above are merely exemplary, where the units described as separate components may or may not be physically separate, and the components illustrated as elements may or may not be physical units, that is, they can be collocated or can be distributed onto a plurality of network elements. A part or all of the modules can be selected as needed in reality for the purpose of the solution according to the embodiments of the application.

### Eighth Embodiment

The embodiment of the present application further provides a computer program product, where the computer program product includes a computer program stored on a non-transitory computer-readable storage medium, the computer program includes program instructions, and the program instructions, when being executed by a computer, cause the computer to perform any one of the methods above.

Through the description on the embodiments, those skilled in the art can clearly know that respective embodiments can be implemented by means of software plus a universal hardware platform, or by hardware of course. Based on such understanding, the above technical solution or the part contributing to the prior art can be embodied in a software product manner essentially, the computer software product can be stored in the computer readable storage medium, for example, ROM/RAM, a disk, a compact disk, etc., and includes a plurality of instructions to enable a computer device (which can be a personal computer, a server, or a network device, etc.) to execute the method according to respective embodiments or some parts of the embodiments.

Lastly it shall be noted that the respective embodiments above are merely intended to illustrate but not to limit the technical solution of the application; and although the application has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A file storage method, applied to a terminal, comprising:
receiving a file to be stored;
determining a currently stored folder with a lowest storage priority after the storage space of a disk exceeds a preset threshold; and
selecting and deleting a file from the determined folder, and storing the file to be stored in the disk.

2. The method according to claim 1, wherein the method further comprises:
setting a storage priority of each folder according to file information stored in each folder.

3. The method according to claim 2, wherein the setting a storage priority of each folder according to file information stored in each folder comprises:
setting a storage priority of each folder according to file content and/or file attribute information of each of all files stored in each folder.

4. The method according to claim 2, wherein the setting a storage priority of each folder according to file information stored in each folder comprises:
setting a storage priority of each folder according to an accessing frequency of each of all files stored in each folder in a latest preset time period.

5. The method according to claim 1, wherein the storing the file to be stored in the disk comprises:
determining a folder to which the file to be stored belongs in the disk; and
storing the file to be stored in the determined folder.

6. A non-transitory computer storage medium storing a computer executable instruction, wherein the computer executable instruction is set for:
receiving a file to be stored;
determining a currently stored folder with a lowest storage priority after the storage space of a disk exceeds a preset threshold; and
selecting and deleting a file from the determined folder, and storing the file to be stored in the disk.

7. The non-transitory computer storage medium according to claim 6, wherein the computer executable instruction further comprises:
setting a storage priority of each folder according to file information stored in each folder.

8. The non-transitory computer storage medium according to claim 7, wherein the setting a storage priority of each folder according to file information stored in each folder comprises:
setting a storage priority of each folder according to file content and/or file attribute information of each of all files stored in each folder.

9. The non-transitory computer storage medium according to claim 7, wherein the setting a storage priority of each folder according to file information stored in each folder comprises:
setting a storage priority of each folder according to an accessing frequency of each of all files stored in each folder in a latest preset time period.

10. The non-transitory computer storage medium according to claim 6, wherein the storing the file to be stored in the disk comprises:
determining a folder to which the file to be stored belongs in the disk; and
storing the file to be stored in the determined folder.

11. An electronic device, comprising:
at least one processor; and
a memory communicably connected with the at least one processor;
wherein the memory stores instructions executable by the at least one processor, and execution of the instructions by the at least one processor causes the at least one processor to:
receive a file to be stored;
determine a currently stored folder with a lowest storage priority after the storage space of a disk exceeds a preset threshold; and
select and delete a file from the determined folder, and store the file to be stored in the disk.

12. The electronic device according to claim 11, wherein the execution of the instructions by the at least one processor further causes the at least one processor to:
set a storage priority of each folder according to file information stored in each folder.

13. The electronic device according to claim 12, wherein the setting a storage priority of each folder according to file information stored in each folder comprises:
setting a storage priority of each folder according to file content and/or file attribute information of each of all files stored in each folder.

14. The electronic device according to claim 12, wherein the setting a storage priority of each folder according to file information stored in each folder comprises:
setting a storage priority of each folder according to an accessing frequency of each of all files stored in each folder in a latest preset time period.

15. The electronic device according to claim 11, wherein the storing the file to be stored in the disk comprises:
determining a folder to which the file to be stored belongs in the disk; and
storing the file to be stored in the determined folder.
